(19) United States
(12) Patent Application Publication
(10) Pub. No.: US 2012/0163494 A1
(43) Pub. Date: Jun. 28, 2012

(54) APPARATUS AND METHOD FOR TRANSMITTING AND RECEIVING ADDITIONAL DATA USING TIME-DELAY INFORMATION OF SEQUENCE IN DIGITAL BROADCASTING SYSTEM

(75) Inventors: You-Seok LEE, Daejeon (KR); Heung-Mook KIM, Daejeon (KR)

(73) Assignee: ELECTRONICS AND TELECOMMUNICATIONS RESEARCH INSTITUTE, Daejeon (KR)

(21) Appl. No.: 13/334,578

(22) Filed: Dec. 22, 2011

(30) Foreign Application Priority Data
Dec. 22, 2010 (KR) 10-2010-0132389

(51) Int. Cl. H04L 27/04; H04L 27/06

(52) U.S. Cl. 375/295; 375/340

(57) ABSTRACT

An apparatus for transmitting a main broadcasting signal and additional data in a digital broadcasting system includes: an orthogonal sequence generation unit configured to generate an orthogonal sequence having orthogonality with the main broadcasting signal; an orthogonal sequence delay unit configured to delay the generated orthogonal sequence according to inputted additional data; a signal mixing unit configured to mix the delayed orthogonal sequence with the main broadcasting signal and generate a mixed signal; and a transmission unit configured to transmit the mixed signal.

### CROSS-REFERENCE TO RELATED APPLICATIONS

The present application claims priority of Korean Patent Application No. 10-2010-0132389, filed on Dec. 22, 2010, which is incorporated herein by reference in its entirety.

### BACKGROUND OF THE INVENTION

1. Field of the Invention

Exemplary embodiments of the present invention relate to an apparatus and method for transmitting and receiving additional data in a broadcasting and communication system; and, more particularly, to an apparatus and method for transmitting and receiving additional data using time-delay information of an orthogonal sequence having orthogonality with a main broadcasting signal in a broadcasting and communication system.

2. Description of Related Art

In general, a digital broadcasting system refers to a broadcasting system which provides a high-quality video service by using digital data. The digital broadcasting system provides a variety of additional information related to a broadcasting program to viewers such that the viewers may refer to the information of the broadcasting program. For example, the additional information may include information on what kind of broadcasting program is currently provided to a user, which channel is a current broadcasting channel, or at what time a broadcasting program to be provided from now on will start or end. Furthermore, the additional information may include transmitter identification information or notice information which is discriminated from broadcasting programs.

Such additional information is transmitted together with video data for actual broadcasting from a digital broadcasting station.

FIG. 1 is a diagram illustrating a conventional apparatus for transmitting and receiving additional signals while maintaining backward compatibility with digital broadcasting signals.

Referring to FIG. 1, the conventional apparatus for transmitting digital broadcasting data and additional data includes a main signal generation unit 101, an additional signal generation unit 102, a power control unit 103, a signal mixing unit 104, and a mixed signal transmission unit 105. And the conventional apparatus for receiving digital broadcasting data and additional data includes a mixed signal reception unit 106, a main data restoration unit 107, a main data generation unit 108, an additional data restoration unit 109, and an additional data generation unit 110.

The operation of the conventional apparatus for transmitting and receiving digital broadcasting data and additional data will be described in detail.

The main signal generation unit 101 is configured to receive digital broadcasting data and generate a baseband main signal.

The additional signal generation unit 102 is configured to receive additional data and generate a baseband additional signal. The power control unit 103 is configured to control the average power of the additional signal generated by the additional signal generation unit 102 such that the additional signal does not have an effect upon the main signal generated by the main signal generation unit 101.

The signal mixing unit 104 is configured to insert the additional signal, of which the average power was controlled by the power control unit 103, into the main signal generated by the main signal generation unit 101, thereby generating a mixed signal in which the main signal and the additional signal are mixed.

The mixed signal transmission unit 105 is configured to transmit the mixed signal generated by the signal mixing unit 104.

The mixed signal reception unit 106 is configured to receive the mixed signal which is transmitted by the mixed signal transmission unit 105 and in which the digital broadcasting signal and the additional data are mixed.

The main signal restoration unit 107 is configured to receive the mixed signal received by the mixed signal reception unit 106 and restore the main signal. The main data generation unit 108 is configured to generate main data from the main signal inputted from the main signal restoration unit 107.

The additional signal restoration unit 109 is configured to restore the additional signal by using the mixed signal inputted from the mixed signal reception unit 106 and the main signal inputted from the main signal generation unit 107.

The additional data generation unit 110 is configured to generate additional data by using the signal inputted from the additional signal restoration unit 109.

Such a conventional apparatus for transmitting and receiving additional data has an advantage in that it may transmit and receive a digital broadcasting signal and additional data at the same time.

In order to transmit additional data, the transmission apparatus allocates a transmission bit to a sequence used for transmitter discrimination. The reception apparatus detects the received additional data through despreading. However, the conventional apparatus for transmitting and receiving additional data has a disadvantage in that the transmission capacity thereof is limited to about 160 bps or less. Therefore, another method for increasing the transmission capacity for additional data is required.

### SUMMARY OF THE INVENTION

An embodiment of the present invention is directed to an apparatus and method for transmitting and receiving additional data, which is capable of increasing the transmission rate of a digital broadcasting system by transmitting and receiving additional data while maintaining backward compatibility with a digital broadcasting signal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for transmitting a main broadcasting signal and additional data in a digital broadcasting system includes: an orthogonal sequence generation unit configured to generate an orthogonal sequence having orthogonality with the main broadcasting signal; an orthogonal sequence delay unit configured to delay the generated orthogonal sequence according to inputted additional data; a signal mixing unit configured to mix the delayed orthogonal sequence with the main broadcasting signal and generate a mixed signal; and a transmission unit configured to transmit the mixed signal.

The apparatus may further include a power control unit configured to control the average power of the orthogonal sequence signal outputted by the orthogonal sequence delay unit such that the orthogonal sequence signal does not have an effect upon the main broadcasting signal, and transfer the orthogonal sequence signal to the signal mixing unit.

The orthogonal sequence delay unit may delay the orthogonal sequence based on a point which is promised by an apparatus for receiving additional data.

The signal mixing unit may mix the delayed orthogonal sequence with main broadcasting data within a delay period indicating a delay range of the orthogonal sequence excluding a synchronization field, and outputs the mixed signal.

In accordance with another embodiment of the present invention, an apparatus for receiving a main broadcasting signal and additional data in a digital broadcasting system includes: a mixed signal reception unit configured to receive a mixed signal; an orthogonal sequence generation unit configured to generate the same orthogonal sequence as used in an apparatus for transmitting additional data, the orthogonal sequence having orthogonality with the main broadcasting signal; an orthogonal sequence delay detection unit configured to detect a time-delay degree of an orthogonal sequence signal mixed in the mixed signal transferred from the mixed signal reception unit by using the orthogonal sequence generated by the orthogonal sequence generation unit; and an additional data generation unit configured to generate additional data based on the time-delay degree of the orthogonal sequence signal detected by the orthogonal sequence delay detection unit.

The orthogonal sequence delay detection unit may detect the position of a correlation peak through the correlation between the mixed signal and the orthogonal sequence generated by the orthogonal sequence generation unit, and detects the time-delay degree based on the detected position of the correlation peak.

In accordance with another embodiment of the present invention, a for transmitting a main broadcasting signal and additional data in a digital broadcasting system includes: setting a delay period indicating a delay range of one orthogonal sequence and an orthogonal sequence used in the same manner by a transmission side and a reception side and having orthogonality with the main broadcasting signal; generating the orthogonal sequence; delaying the generated orthogonal sequence according to inputted additional data; mixing the delayed orthogonal sequence signal with the main broadcasting signal and transmitting the mixed signal.

In accordance with another embodiment of the present invention, a method for receiving a main broadcasting signal and additional data in a digital broadcasting system includes: setting a delay period indicating a delay range of one orthogonal sequence and an orthogonal sequence used in the same manner by a transmission side and a reception side and having orthogonality with the main broadcasting signal; receiving a mixed signal in which the main broadcasting signal and a delayed orthogonal sequence signal are mixed; generating the orthogonal sequence; detecting a time-delay degree of the orthogonal sequence signal from the mixed signal by using the generated orthogonal sequence; and generating additional data based on the detected time-delay degree of the orthogonal sequence signal.

### BRIEF DESCRIPTION OF THE DRAWINGS

FIG. 1 is a diagram illustrating a conventional apparatus for transmitting and receiving additional data.

FIG. 2 is a configuration diagram of an apparatus for transmitting digital broadcasting data and additional data in accordance with an embodiment of the present invention.

FIG. 3 is a diagram explaining a process in which a delayed orthogonal sequence is mixed with a main signal and transmitted.

FIG. 4 is a configuration diagram of the apparatus for receiving digital broadcasting data and additional data in accordance with another embodiment of the present invention.

FIG. 5 is a flow chart explaining a method for transmitting additional data using a delayed orthogonal sequence in accordance with another embodiment of the present invention.

FIG. 6 is a flow chart explaining a method for receiving additional data using a delayed orthogonal sequence in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

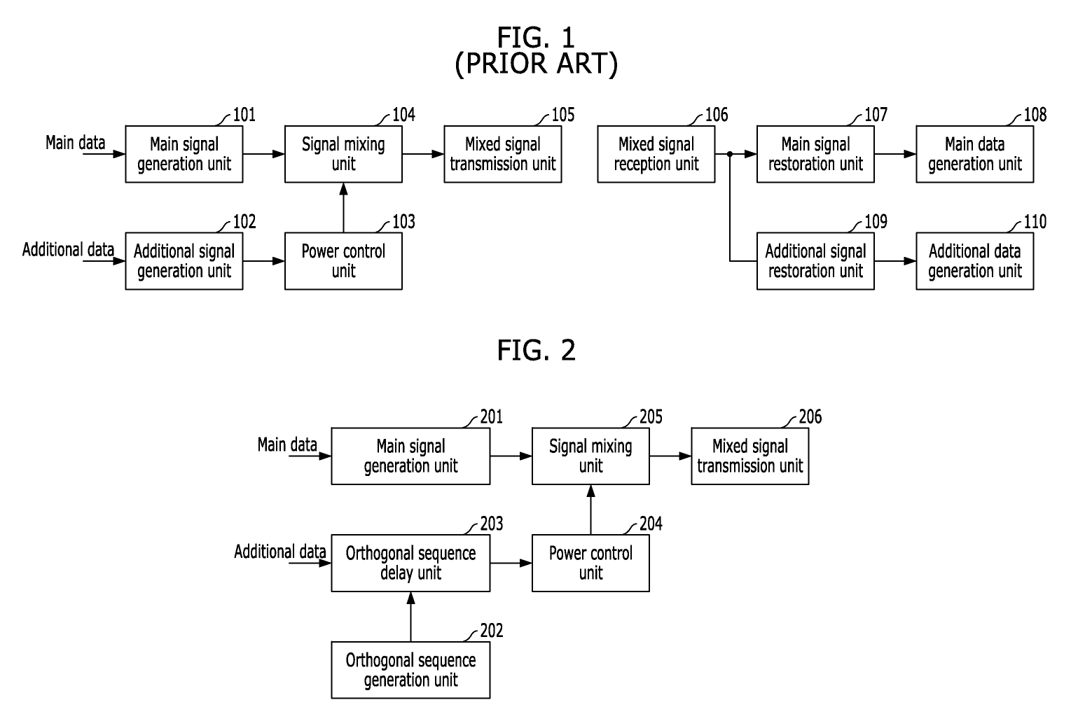

FIG. 2 is a configuration diagram of an apparatus for transmitting digital broadcasting data and additional data in accordance with an embodiment of the present invention.

Referring to FIG. 2, the apparatus for transmitting digital broadcasting data and additional data in accordance with the embodiment of the present invention includes a main signal generation unit 201, an orthogonal sequence generation unit 202, an orthogonal sequence delay unit 203, a power control unit 204, a signal mixing unit 205, and a mixed signal transmission unit 206. The main signal generation unit 201 is configured to receive main data and generate a main signal. The orthogonal sequence generation unit 202 is configured to generate an orthogonal sequence having orthogonality with broadcasting data for transmission of additional data. The orthogonal sequence delay unit 203 is configured to receive additional data and delay the orthogonal sequence inputted from the orthogonal sequence generation unit 202 to represent the additional data. The power control unit 204 is configured to control the average power of the orthogonal sequence signal delayed by the orthogonal sequence delay unit 203. The signal mixing unit 205 is configured to mix the main signal generated by the main signal generation unit 201 with the orthogonal sequence signal of which the average power is controlled by the power control unit 204, and generate a mixed signal. The mixed signal transmission unit 206 is configured to transmit the mixed signal generated by the signal mixing unit 205.

The operation of the apparatus for transmitting digital broadcasting data and additional data in accordance with the embodiment of the present invention will be described in detail.

The main signal generation unit 201 receives digital broadcasting data and generates a baseband main signal.

The orthogonal sequence generation unit 202 generates the same orthogonal sequence as generated by an orthogonal sequence generation unit included in an apparatus for receiving digital data broadcasting data and additional data. At this time, the orthogonal signal generation unit 202 generates a template sequence having orthogonality with the main data.

The orthogonal delay unit 203 receives additional data and delays the orthogonal sequence generated by the orthogonal sequence generation unit 202 to express the inputted additional data. For example, when 6-bit additional data is transmitted, 6-bit information may be expressed as the time-delay of the orthogonal sequence. Therefore, 64 (2⁶) delays need to be discriminated. In this case, numbers of zero to 63 may be expressed. Specifically, when additional data to be transmitted is represented by “000011”, the orthogonal sequence is delayed by 3 symbols, and the delayed orthogonal signal is then mixed with the main signal and transmitted. The reception apparatus may acquire the time-delay information by detecting the position of a correlation peak through correlation analysis. Accordingly, the reception apparatus may generate 6-bit additional data.

When the polarity of the template sequence generated by the orthogonal sequence generation unit 202 is changed, one bit may be additionally expressed. Furthermore, when the number of template sequences is increased, it is possible to increase the transmission capacity.

The power control unit 204 controls the average power of the delayed orthogonal sequence signal inputted from the orthogonal sequence delay unit 203 such that the orthogonal sequence signal does not have an effect upon the main signal generated by the signal generation unit 201, and then transfers the controlled orthogonal sequence signal to the signal mixing unit 205.

When the signal outputted from the orthogonal sequence delay unit does not have an effect upon the main signal, the power control unit may not be required.

The signal mixing unit 205 mixes the orthogonal sequence signal, of which the average power was controlled by the power control unit 204, with the main signal generated by the main signal generation unit 201 at low power, and generates a mixed signal.

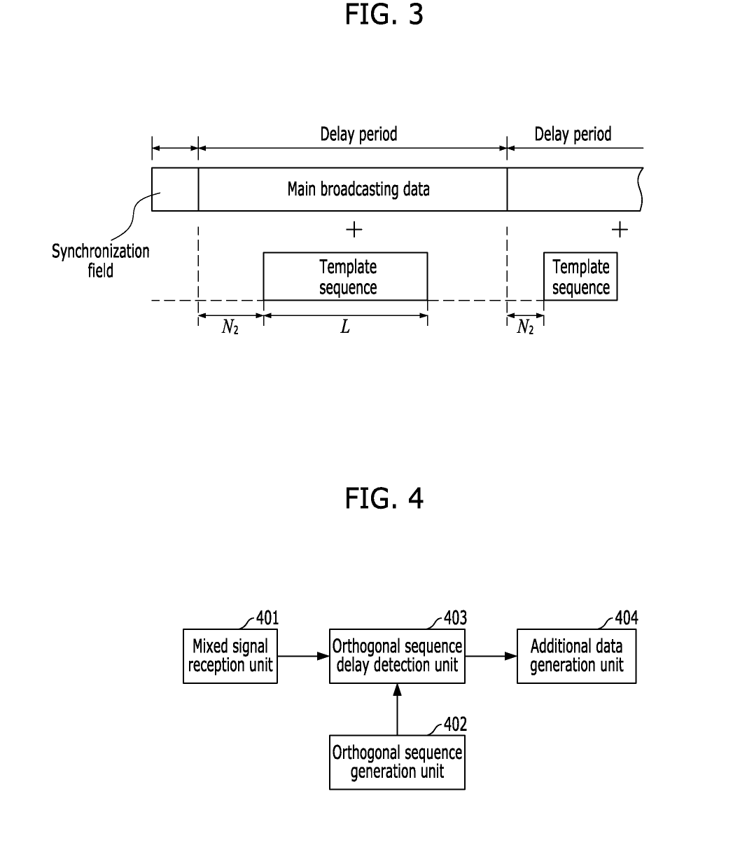

FIG. 3 is a diagram explaining a process in which the delayed orthogonal sequence is mixed with the main signal and transmitted.

Referring to FIG. 3, the delayed orthogonal sequence signal is mixed at low power during a data period excluding a synchronization field, and then transmitted. Here, a delay period indicates a range in which one template sequence may be delayed. In FIG. 3, L represents the length of a template sequence, and N₁ and N₂ represent a delay time of a template sequence. When additional data includes six bits, numbers of 0 to 63 may be expressed through the delay time.

The orthogonal sequence delay unit 203 may delay the template sequence based on a point which is promised by the reception apparatus. Then, the reception apparatus may acquire the time-delay information of the orthogonal sequence by detecting the position of the correlation peak.

The mixed signal transmission unit 206 transmits the mixed signal generated by the signal mixing unit 205.

FIG. 4 is a configuration diagram of the apparatus for receiving digital broadcasting data and additional data in accordance with another embodiment of the present invention.

Referring to FIG. 4, the apparatus for receiving digital broadcasting data and additional data includes a mixed signal reception unit 401, an orthogonal sequence generation unit 402, an orthogonal sequence delay detection unit 403, and an additional data generation unit 404. The mixed signal reception unit 401 is configured to receive the mixed signal in which the main signal and the delayed orthogonal sequence signal are mixed. The orthogonal sequence generation unit 402 is configured to generate the orthogonal sequence used in the transmission apparatus, in order for restoration of additional data. The orthogonal sequence delay detection unit 403 is configured to detect the time-delay degree of the orthogonal sequence from the mixed signal inputted from the mixed signal reception unit 401 by using the orthogonal sequence generated by the orthogonal sequence generation unit 402. The additional data generation unit 404 is configured to generate additional data by using the time-delay information of the orthogonal sequence detected by the orthogonal sequence delay detection unit 403.

The operation of the apparatus for receiving digital broadcasting data and additional data in accordance with the embodiment of the present invention will be described in detail.

The mixed signal reception unit 401 receives a mixed signal transmitted through a free space, and outputs the baseband mixed signal.

The orthogonal sequence generation unit 402 generates the same orthogonal sequence as used in the orthogonal sequence generation unit 202 of the transmission apparatus. That is, the orthogonal sequence generation unit 402 generates the same template sequence as used in the transmission apparatus, the template sequence having orthogonality with main data.

The orthogonal sequence delay detection unit 403 detects the position of a correlation peak by correlating the orthogonal sequence generated by the orthogonal sequence generation unit 402 with the mixed signal received by the mixed signal reception unit 401, and detects the time-delay degree of the orthogonal sequence by using the detected position of the correlation peak. In other words, the transmission apparatus and the reception apparatus may delay the generated template sequence on the basis of the promised point, and correlate the same template sequence as used in the transmission apparatus with the mixed signal, thereby detecting the correlation peak position. Furthermore, the information on the time-delay degree of the template sequence may be acquired by using the correlation peak position.

The additional data generation unit 404 generates corresponding additional data based on the time-delay degree of the orthogonal sequence, which is detected by the orthogonal sequence delay detection unit 403. For example, when 6-bit additional data is used and it is determined that the orthogonal sequence is delayed by three symbols, the additional data generation unit generates additional data of “000011”.

Accordingly, the transmission apparatus may delay the template sequence to express the additional data while having orthogonality with the digital broadcasting data, mix the delayed template sequence with the digital broadcasting data at low power, and transmit the mixed signal. The reception apparatus may detect the time-delay information of the template sequence and generate the corresponding additional data.

Meanwhile, FIG. 4 does not illustrate a main signal restoration unit for restoring a main signal and a main data generation unit. As in the conventional apparatus, however, it is possible to implement a unit which restores a main signal from the mixed signal received by the mixed signal reception unit 401. Therefore, the detailed descriptions of the main signal restoration will be omitted herein.

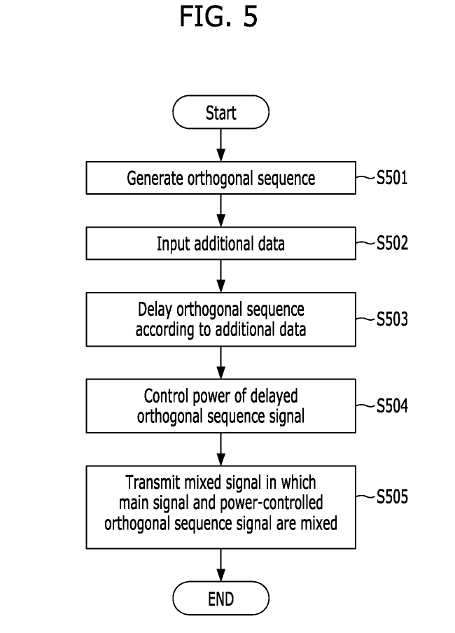

FIG. 5 is a flow chart explaining a method for transmitting additional data using a delayed orthogonal sequence in accordance with another embodiment of the present invention.

Referring to FIG. 5, the additional data transmission apparatus and the additional data reception unit set a delay period in which one template sequence may be delayed. Furthermore, the additional data transmission apparatus generates the same template sequence as used in the reception apparatus, the template sequence having orthogonality with a main broadcasting signal, at step S501.

When additional data to be transmitted is inputted at step S502, the transmission apparatus delays the generated orthogonal sequence by a predetermined time according to the inputted additional data, and outputs the delayed orthogonal sequence at step S503. For example, when 6-bit additional data is represented by “000011”, the transmission apparatus delays the orthogonal sequence by three symbols.

The transmission apparatus controls the average power of the delayed orthogonal sequence signal to a low level such that the orthogonal sequence signal does not have an effect upon the main broadcasting signal, at step S504. Then, the transmission apparatus mixes the template sequence, of which the power was controlled, with the main signal and transmits the mixed signal at step S505.

In FIG. 5, the orthogonal sequence generation and the additional data input may not be sequentially performed, but may be performed regardless of the sequence.

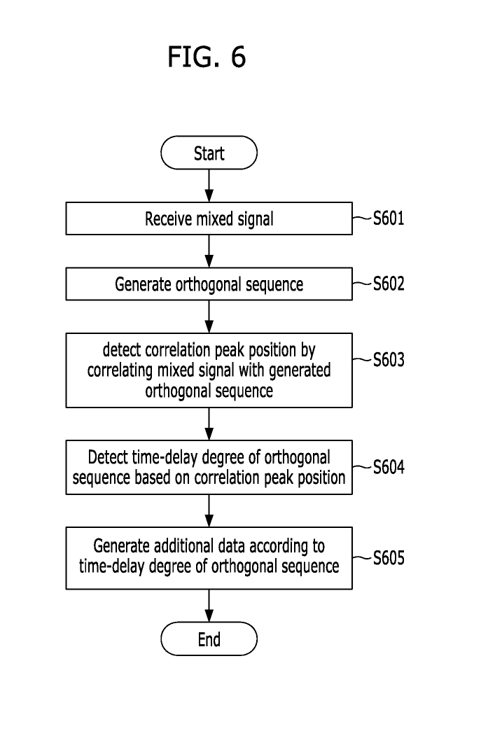

FIG. 6 is a flow chart explaining a method for receiving additional data using a delayed orthogonal sequence in accordance with another embodiment of the present invention.

Referring to FIG. 6, the reception apparatus receives a mixed signal transmitted through a free space at step S601, and simultaneously generate the same orthogonal sequence as used in the additional data transmission apparatus at step S602. That is, the reception apparatus generates the same template sequence as used in the transmission apparatus, the template sequence having orthogonality with a main broadcasting signal.

The reception apparatus detects the position of a correlation peak by correlating the generated orthogonal sequence with the received mixed signal at step S603. The reception apparatus detects the time-delay degree of the orthogonal sequence by using the detected position of the correlation peak at step S604. In other words, the transmission apparatus and the reception apparatus may delay the generated template sequence based on a promised point, and the reception apparatus may detect the correlation peak position by correlating the same template signal as used in the transmission apparatus with the mixed signal. Furthermore, the reception apparatus may acquire information on the time-delay degree of the template sequence by using the correlation peak position.

The reception apparatus detects the time-delay degree of the template sequence, and generates the corresponding additional data based on the detected time-delay degree at step S605. For example, when 6-bit additional data is used and it is determined that the orthogonal sequence is delayed by three symbols, the reception apparatus generates additional data of “000011”.

In FIG. 6, the mixed signal reception and the orthogonal sequence generation may not be sequentially performed, but may be performed regardless of the sequence.

In accordance with the exemplary embodiments of the present invention, the mixed signal in which the digital broadcasting data and the additional data are mixed is transmitted by using the time-delay information of the orthogonal sequence having orthogonality with the broadcasting signal. Therefore, it is possible to increase the transmission capacity more than the conventional method for transmitting additional data, without having an effect upon the performance of the conventional digital broadcasting receiver.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. An apparatus for transmitting a main broadcasting signal and additional data in a digital broadcasting system, the apparatus comprising:
an orthogonal sequence generation unit configured to generate an orthogonal sequence having orthogonality with the main broadcasting signal;
an orthogonal sequence delay unit configured to delay the generated orthogonal sequence according to inputted additional data;
a signal mixing unit configured to mix the delayed orthogonal sequence with the main broadcasting signal and generate a mixed signal; and
a transmission unit configured to transmit the mixed signal.

2. The apparatus of claim 1, further comprising a power control unit configured to control the average power of the orthogonal sequence signal outputted by the orthogonal sequence delay unit such that the orthogonal sequence signal does not have an effect upon the main broadcasting signal, and transfer the orthogonal sequence signal to the signal mixing unit.

3. The apparatus of claim 2, wherein the orthogonal sequence delay unit delays the orthogonal sequence based on a point which is promised by an apparatus for receiving additional data.

4. The apparatus of claim 2, wherein the signal mixing unit mixes the delayed orthogonal sequence with main broadcasting data within a delay period indicating a delay range of the orthogonal sequence excluding a synchronization field, and outputs the mixed signal.

5. An apparatus for receiving a main broadcasting signal and additional data in a digital broadcasting system, the apparatus comprising:
a mixed signal reception unit configured to receive a mixed signal;
an orthogonal sequence generation unit configured to generate the same orthogonal sequence as used in an apparatus for transmitting additional data, the orthogonal sequence having orthogonality with the main broadcasting signal;
an orthogonal sequence delay detection unit configured to detect a time-delay degree of an orthogonal sequence signal mixed in the mixed signal transferred from the mixed signal reception unit by using the orthogonal sequence generated by the orthogonal sequence generation unit; and
an additional data generation unit configured to generate additional data based on the time-delay degree of the orthogonal sequence signal detected by the orthogonal sequence delay detection unit.

6. The apparatus of claim 5, wherein the orthogonal sequence delay detection unit detects the position of a correlation peak through the correlation between the mixed signal and the orthogonal sequence generated by the orthogonal sequence generation unit, and detects the time-delay degree based on the detected position of the correlation peak.

7. A method for transmitting a main broadcasting signal and additional data in a digital broadcasting system, the method comprising:
setting a delay period indicating a delay range of one orthogonal sequence and an orthogonal sequence used in the same manner by a transmission side and a reception side and having orthogonality with the main broadcasting signal;
generating the orthogonal sequence;
delaying the generated orthogonal sequence according to inputted additional data;
mixing the delayed orthogonal sequence signal with the main broadcasting signal and transmitting the mixed signal.

8. The method of claim 7, wherein, in said mixing the delayed orthogonal sequence signal with the main broadcasting signal and transmitting the mixed signal,
the average power of the delayed orthogonal sequence signal is controlled so as not to have an effect upon the main broadcasting signal, mixed with the main broadcasting signal, and transmitted.

9. The method of claim 7, wherein, in said delaying the generated orthogonal sequence according to the inputted additional data,
the orthogonal sequence is delayed based on a point which is promised by an apparatus for receiving additional data.

10. A method for receiving a main broadcasting signal and additional data in a digital broadcasting system, the method comprising:
setting a delay period indicating a delay range of one orthogonal sequence and an orthogonal sequence used in the same manner by a transmission side and a reception side and having orthogonality with the main broadcasting signal;
receiving a mixed signal in which the main broadcasting signal and a delayed orthogonal sequence signal are mixed;
generating the orthogonal sequence;
detecting a time-delay degree of the orthogonal sequence signal from the mixed signal by using the generated orthogonal sequence; and
generating additional data based on the detected time-delay degree of the orthogonal sequence signal.

11. The method of claim 10, wherein, in said detecting the time-delay degree of the orthogonal sequence signal from the mixed signal by using the generated orthogonal sequence,
the position of a correlation peak is detected through the correlation between the mixed signal and the generated orthogonal sequence, and the time-delay degree is detected based on the detected position of the correlation peak.
